(19) United States
(12) Patent Application Publication
(10) Pub. No.: US 2013/0332725 A1
(43) Pub. Date: Dec. 12, 2013

(54) INFORMATION PROCESSING APPARATUS, INFORMATION PROCESSING SYSTEM, INFORMATION PROCESSING METHOD, AND PROGRAM

(71) Applicant: Sony Corporation, Tokyo (JP)

(72) Inventor: Masanori Inoue, Tokyo (JP)

(73) Assignee: Sony Corporation, Tokyo (JP)

(21) Appl. No.: 13/903,161

(22) Filed: May 28, 2013

(30) Foreign Application Priority Data
Jun. 4, 2012 (JP) 2012-126798

(51) Int. Cl. H04W 12/04; H04W 12/08

(52) U.S. Cl. CPC H04W 12/04; H04W 12/08
USPC 713/155; 713/150

(57) ABSTRACT

An information processing apparatus includes a communication unit and a control unit. The control unit is configured to be capable of controlling the communication unit to receive, from a different information processing apparatus, storage location information representing a storage location of key information necessary for encrypted wireless communication with the different information processing apparatus, to access the storage location represented by the storage location information to receive the key information, and to establish a connection with the different information processing apparatus by using the received key information.

### CROSS-REFERENCE TO RELATED APPLICATION

The present application claims priority from Japanese Patent Application No. JP 2012-126798 filed in the Japanese Patent Office on Jun. 4, 2012, the entire content of which is incorporated herein by reference.

### BACKGROUND

The present disclosure relates to an information processing apparatus that is capable of wirelessly communicating with another apparatus, an information processing system including the information processing apparatus, an information processing method in the information processing apparatus, and a program.

### SUMMARY

As a standard of setting up for communication through a WLAN (Wireless Local Area Network) (e.g., Wi-Fi conforming to IEEE802.11), a WPS (Wi-Fi Protected Set up) developed by the Wi-Fi Alliance(WFA) has been known in the past (see, for example, Japanese Unexamined Patent Application Publication No. 2010-518779). The WPS is a standard that attempts to make it possible to simplify the procedure for setting up the WLAN and to enhance the security. Examples of a specific method of the WPS include a push-button method and a PIN (Personal Identification Number) code method.

In the push-button method, by pushing respective dedicated buttons mounted on an access point and a client device, a key (WPA2 (Wi-Fi Protected Access 2)) or the like to be a source of encryption processing necessary for wireless communication is transmitted, thereby completing the security setting.

In the PIN code method, a four or eight-digit number (PIN code), which is allocated to a client device in advance, is input in the client device or a registrar, thereby completing the security setting.

In the push-button method, however, the key information can be simultaneously transmitted between only one pair of an access point and a client device, and a session overlap occurs in the case where setting up processing of the WPS is being executed between the access point and another device, resulting in failure of the setting up processing. On the other hand, in the PIN code method, a user has to confirm the PIN code to input the PIN code in the device.

In view of the circumstances as described above, it is desirable to provide an information processing apparatus that is capable of reducing the trouble of setting up processing necessary for wireless communication, and executing the setting up processing in a one-to-many network environment, an information processing system, an information processing method, and a program.

According to an embodiment of the present disclosure, there is provided an information processing apparatus including a communication unit and a control unit. The control unit is configured to be capable of controlling the communication unit to receive, from a different information processing apparatus, storage location information representing a storage location of key information necessary for encrypted wireless communication with the different information processing apparatus, to access the storage location represented by the storage location information to receive the key information, and to establish a connection with the different information processing apparatus by using the received key information.

With this configuration, the information processing apparatus does not need a button-pressing operation or input operation of PIN by a user in establishing a wireless connection with the different information processing apparatus (setting up), as compared with the existing method. Moreover, because the key information is stored in the storage location, even if there is another apparatus that is executing the setting up processing between the apparatus and the different information processing apparatus, the information processing apparatus can obtain the key information from the storage location. Therefore, the information processing apparatus can reduce the trouble of setting up processing necessary for wireless communication with the different information processing apparatus, and execute the setting up processing in a one-to-many network environment.

The control unit may control the communication unit to access the storage location by using permission information representing that access to the storage location is permitted by a user of the different information processing apparatus.

With this configuration, because it is difficult for the information processing apparatus to access the storage location of the key information in the case where the information processing apparatus does not have the permission information, the security of the key information is ensured.

The storage location may be a first data area on a first SNS (Social Networking Service) server, the first data area corresponding to a first account for logging in the first SNS server, the user of the different information processing apparatus having the first account. In this case, the control unit may use, as the permission information, an account of a user of the information processing apparatus, which is included in a first friend list corresponding to the first account of the user of the different information processing apparatus.

With this configuration, the information processing apparatus can use, for the security of the key information, a friend list that is already present on the SNS.

The storage location may include the first data area on the first SNS server and a second data area on a second SNS server, the second data area corresponding to a second account for logging in the second SNS server, the user of the different information processing apparatus having the second account, the second SNS server being different from the first SNS server. In this case, the control unit may control the communication unit to use, as the permission information, an account of the user of the information processing apparatus, which is included in at least one of the first friend list and a second friend list, to receive the key information from at least one of the first data area and the second data area, the second friend list corresponding to the second account for logging in the second SNS server, the user of the different information processing apparatus having the second account.

With this configuration, even in the case where the user of the different information processing apparatus has accounts on multiple SNS and the user of the information processing apparatus is not accepted as a friend in any of the SNS, the information processing apparatus can obtain the key information from any one of the SNS servers.

The storage location information may be transmitted, as a beacon, from the different information processing apparatus together with an identifier at a predetermined interval, the identifier identifying the different information processing apparatus.

With this configuration, the information processing apparatus can obtain the storage location information for obtaining the key information without a user's operation.

The key information may be one of a character and a sign, which are described at a predetermined location on a predetermined web page. In this case, the control unit may control the communication unit to receive, as the storage location information, information representing a URL of the web page and the predetermined location, and to extract and receive, as the key information, one of the character and the sign from the predetermined position on the web page.

With this configuration, the different information processing apparatus allows the information processing apparatus to obtain the key information without uploading the key information to any location such as a server.

According to another embodiment of the present disclosure, there is provided an information processing system including an information processing apparatus and a server. The information processing apparatus includes a first communication unit and a first control unit. The first control unit is configured to be capable of controlling the first communication unit to receive, from a different information processing apparatus, storage location information representing a storage location of key information necessary for encrypted wireless communication with the different information processing apparatus, to access the storage location represented by the storage location information to receive the key information, and to establish a connection with the different information processing apparatus by using the received key information.

The server includes a storage unit, a second communication unit, and a second control unit. The second control unit is configured to be capable of controlling the second communication unit to authenticate access authority from the information processing apparatus, and to transmit the key information stored at the storage location to the information processing apparatus in a case where the access authority is permitted.

According to still another embodiment, there is provided an information processing method including receiving, from a different information processing apparatus, storage location information representing a storage location of key information necessary for encrypted wireless communication with the different information processing apparatus, accessing the storage location represented by the storage location information to receive the key information, and establishing a connection with the different information processing apparatus by using the received key information.

According to still another embodiment, there is provided a program that causes an information processing apparatus to execute the steps of receiving, from a different information processing apparatus, storage location information representing a storage location of key information necessary for encrypted wireless communication with the different information processing apparatus, accessing the storage location represented by the storage location information to receive the key information, and establishing a connection with the different information processing apparatus by using the received key information.

As described above, according to the present disclosure, it is possible to reduce the trouble of setting up processing necessary for wireless communication, and execute the setting up processing in a one-to-many network environment.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a network configuration of a system according to a first embodiment of the present disclosure;

FIG. 2 is a block diagram showing a hardware configuration of an SNS server in the system;

FIG. 3 is a block diagram showing a hardware configuration of a wireless device in the system;

FIG. 4 is a diagram showing a configuration of a data area in the SNS server;

FIG. 5 is a diagram showing a list of accounts of users of wireless devices for the SNS server;

FIG. 6 is a diagram showing a permission relationship between the accounts of the users of the wireless devices shown in FIG. 5;

FIG. 7 is a sequence diagram showing flow of an operation of the system according to the first embodiment of the present disclosure;

FIG. 8 is a diagram schematically showing the flow of the operation of the system according to the first embodiment of the present disclosure;

FIG. 9 is a diagram schematically showing the flow of the operation of the system according to the first embodiment of the present disclosure;

FIG. 10 is a diagram schematically showing the flow of the operation of the system according to the first embodiment of the present disclosure;

FIG. 11 is a diagram schematically showing the flow of the operation of the system according to the first embodiment of the present disclosure;

FIG. 12 is a diagram schematically showing the flow of the operation of the system according to the first embodiment of the present disclosure;

FIG. 13 is a diagram showing a list of accounts of users of wireless devices for a plurality of servers according to a second embodiment of the present disclosure;

FIGS. 14A-14B are diagrams each showing a permission relationship between the accounts of the users of the wireless devices shown in FIG. 13;

FIG. 15 is a sequence diagram showing flow of an operation of a system according to the second embodiment of the present disclosure;

FIG. 16 is a diagram schematically showing the flow of the operation of the system according to the second embodiment of the present disclosure;

FIG. 17 is a diagram schematically showing the flow of the operation of the system according to the second embodiment of the present disclosure;

FIG. 18 is a diagram schematically showing the flow of the operation of the system according to the second embodiment of the present disclosure;

FIG. 19 is a diagram schematically showing the flow of the operation of the system according to the second embodiment of the present disclosure;

FIG. 20 is a diagram schematically showing the flow of the operation of the system according to the second embodiment of the present disclosure;

FIG. 21 is a diagram schematically showing the flow of the operation of the system according to the second embodiment of the present disclosure; and

FIG. 22 is a diagram schematically showing the flow of the operation of the system according to the second embodiment of the present disclosure.

### DETAILED DESCRIPTION OF EMBODIMENTS

Hereinafter, embodiments according to the present disclosure will be described with reference to the drawings.

### First Embodiment

First, a first embodiment of the present disclosure will be described.

### [Network Configuration of System]

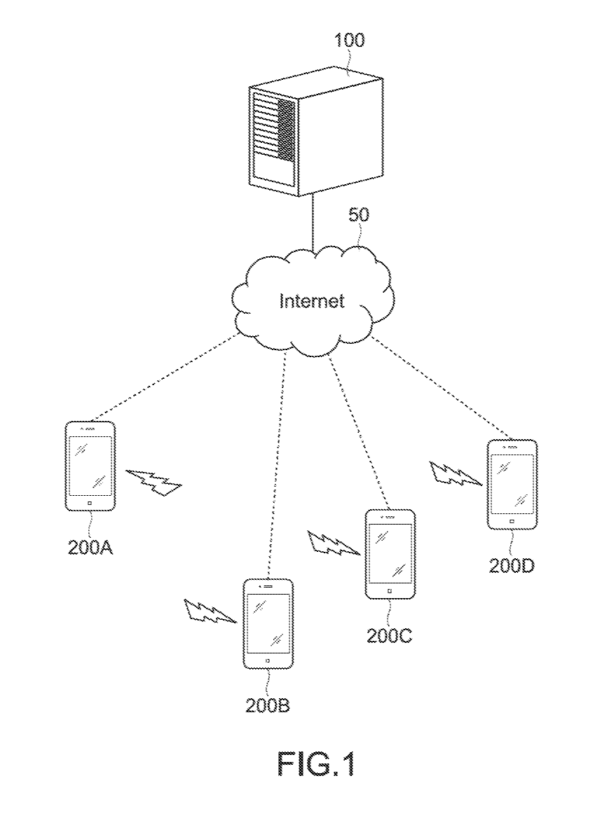

FIG. 1 is a diagram showing a network configuration of a system according to this embodiment.

As shown in FIG. 1, the system includes an SNS (Social Networking Service) server 100 on cloud computing and a plurality of wireless devices 200 (200A to 200D). The SNS server 100 and the wireless devices 200 are capable of communicating with each other through a network 50 such as the internet.

The SNS server 100 establishes a social network between users of the wireless devices 200, and provides communication service (social network service) between the users. In this embodiment, at least one of the users of the wireless devices 200A to 200D have an account of the SNS.

The wireless devices 200 (200A to 200D) may be any information processing apparatus such as a smartphone, a mobile phone, a tablet PC (Personal Computer), a desktop PC, a notebook PC, a PDA (Personal Digital Assistant), a portable AV (Audio-visual) player, an electronic book, a digital still camera, a camcorder, a television receiver, a PVR (Personal Video Recorder), a game machine, a projector, a car navigation system, a digital photo frame, an HDD (Hard Disk Drive) apparatus, a healthcare apparatus, and a household appliance.

In FIG. 1, four terminals are shown as the wireless devices 200. However, the number of wireless devices 200 may be less than four or more than five.

The wireless device 200 has a communication unit that is capable of wirelessly communicating with another terminal through, for example, Wi-Fi or Wi-Fi Direct network. For the wireless communication between the wireless devices 200, it needs key information (e.g., PSK (Pre Shared Key)) for encryption or authentication conforming to WPA2-AES or the like. When the wireless device 200 actually performs wireless communication, setting up (registration) processing for exchanging the key information between the terminals needs to be performed.

Moreover, at least one of the wireless devices 200A to 200D may be a dedicated access point. However, the wireless devices 200A to 200D can each function as a group owner having a function such as an access point by, for example, Wi-Fi Direct.

In the following description, the wireless devices 200A, 200B, 200C, and 200D are sometimes referred to as wireless device A, wireless device B, wireless device C, and wireless device D, respectively.

### [Hardware Configuration of SNS Server]

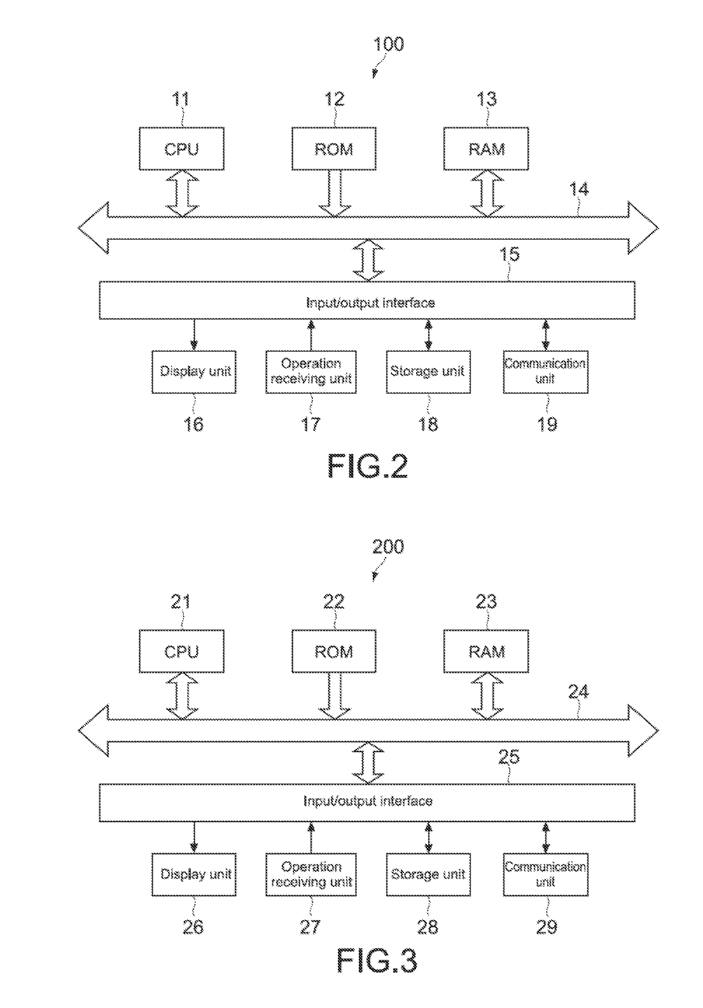

FIG. 2 is a diagram showing a hardware configuration of the SNS server 100. As shown in FIG. 2, the SNS server 100 includes a CPU (Central Processing Unit) 11, a ROM (Read Only Memory) 12, a RAM (Random Access Memory) 13, an input/output interface 15, and a bus 14 that connects those components to each other.

The CPU 11 arbitrarily accesses the RAM 13 or the like as necessary and integrally controls the entire blocks of the SNS server 100 while performing various types of calculation processing. The ROM 12 is a non-volatile memory in which an OS (Operating System) to be executed by the CPU 11 and firmware such as a program and various parameters are statically stored. The RAM 13 is used as, for example, a work area of the CPU 11, and temporarily stores the OS, various applications being executed and various types of data being processed.

To the input/output interface 15, a display unit 16, an operation receiving unit 17, a storage unit 18, a communication unit 19 and the like are connected.

The display unit 16 is, for example, a display device using an LCD (Liquid Crystal Display), an OELD (Organic ElectroLuminescence Display), a CRT (Cathode Ray Tube), or the like.

The operation receiving unit 17 is, for example, a pointing device such as a mouse, a keyboard, a touch panel, or another input apparatus. In the case where the operation receiving unit 17 is a touch panel, the touch panel may be integrated with the display unit 16.

The storage unit 18 is, for example, a non-volatile memory such as an HDD (Hard Disk Drive), a flash memory (SSD; Solid State Drive), and another solid-state memory. In the storage unit 18, the OS, various applications, various types of data are stored. In particular, in this embodiment, a data area for each account of users of the wireless devices 200 is set in the storage unit 18, as will be described later. Only the wireless device 200 corresponding to the account is capable of accessing the data area. In the data area, the key information necessary for wireless communication between the wireless devices 200 is stored. Moreover, data such as a list of the account and a friend list representing the permission relationship between the users is also stored in the storage unit 18.

The communication unit 19 is a NIC (Network Interface Card) or a wireless communication unit for connecting to the network 50, and performs communication processing between the SNS server 100 and the respective wireless devices 200.

### [Hardware Configuration of Wireless Device]

FIG. 3 is a diagram showing a hardware configuration of the wireless devices 200 (200A to 200D). As shown in FIG. 3, also the hardware configuration of the wireless devices 200 is basically the same as that of the SNS server 100. Specifically, the wireless device 200 has a CPU 21, a ROM 22, a RAM 23, an input/output interface 25, a bus 24 that connects those components to each other, a display unit 26, an operation receiving unit 27, a storage unit 28, and a communication unit 29.

Here, the display unit 26 may be incorporated into the wireless device 200, and may be externally connected to the wireless device 200.

The CPU 21 controls the respective blocks such as the storage unit 28 and the communication unit 29, and performs communication processing between the wireless device 200 and the SNS server 100, or various types of data processing.

In the storage unit 28, for example, a program such as a software module necessary for obtaining processing of key information, which will be described later, or various databases are stored. Such a program may be provided to the wireless device 200 through the network 50, or may be provided as a storage medium that can be read in the wireless device 200.

The communication unit 29 includes at least one wireless communication unit that is capable of performing communication through the Wi-Fi or Wi-Fi Direct network. Moreover, the communication unit 29 may include a wired communication unit that is capable of performing communication through Ethernet (registered trademark) or the like. Communication with a different wireless device is performed by the wireless communication unit. However, communication with the SNS server 100 may be performed by any one of the wireless communication unit and the wired communication unit.

### [Data Area of SNS Server]

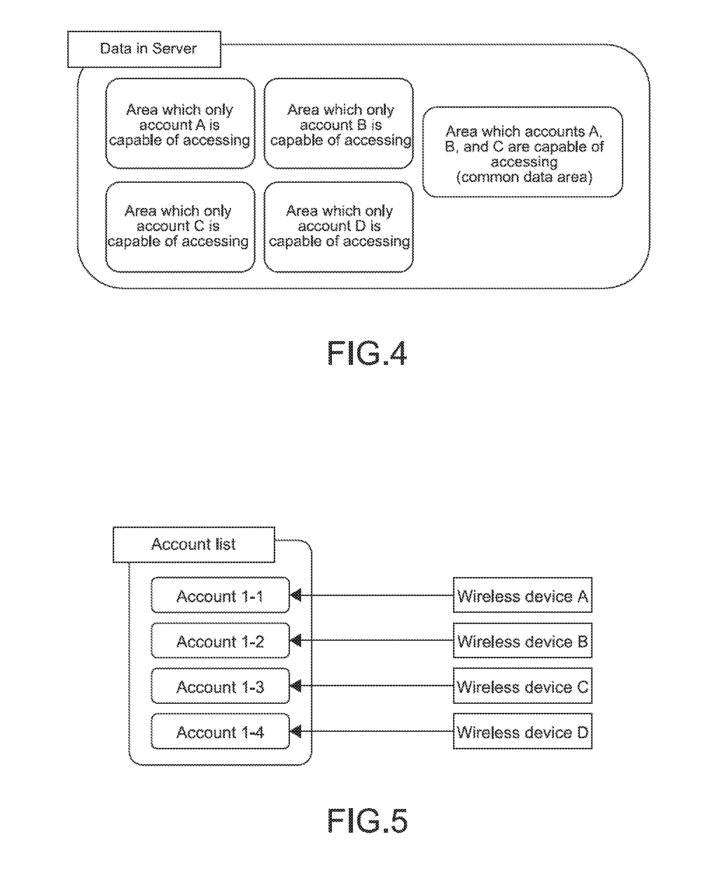

Next, a data area in the SNS server 100 will be described. FIG. 4 is a diagram showing a configuration of the data area in the SNS server 100.

As shown in FIG. 4, in the SNS server 100, a data area for each account of the users of the wireless devices 200 is provided. Only the wireless device 200 corresponding to the account is capable of accessing the data area.

In addition to the data area for each account, a common data area is provided. Only the wireless device 200 corresponding to a permitted account is capable of accessing the common data area. For example, in FIG. 4, the SNS server 100 includes four accounts A, B, C, and D. If A, B, and C are permitted to each other, there is a common data area which only the wireless device 200 having the account A, B, or C is capable of accessing. Examples of such a common data area include a diary or profile of each user of the SNS. However, it is not limited thereto.

### [Account List of Wireless Device]

The SNS server 100 stores a list of accounts corresponding to the wireless devices 200. FIG. 5 is a diagram showing the account list.

As shown in FIG. 5, for example, the wireless device A, wireless device B, wireless device C, and wireless device D have accounts 1-1, 1-2, 1-3, and 1-4, respectively, in the SNS server 100.

### [Permission Relationship Between Accounts]

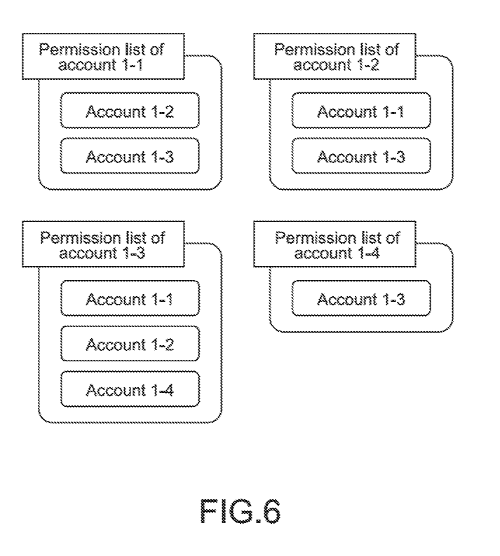

FIG. 6 is a diagram showing a permission relationship (permission list) between the accounts shown in FIG. 5.

As shown in FIG. 6, because a permission list of the account 1-1 includes the accounts 1-2 and 1-3, the user having the account 1-1 (wireless device 200A) accepts users having the account 1-2 (wireless device 200B) and 1-3 (wireless device 200C). Similarly, the user having the account 1-2 accepts the users having the accounts 1-1 and 1-3. The user having the account 1-3 accepts the users having the accounts 1-1, 1-2 and 1-4 (wireless device 200D). The user having the account 1-4 accepts only the user having the account 1-3.

Examples of such a permission list include a friend list and a community member list in the SNS. A user having an account included in the friend list can browse a diary, profile, and the like of a user who has accepted him/her, which are in the common data area.

Specifically, the common data area is a closed area in which users having a trustful relationship can allow sharing of their information, and is a secure area which a user other than such users is not allowed to access. Therefore, by using the common data area as the location information of the key information necessary for wireless communication, the security of the key information is ensured.

### [Operation of System]

Next, operations of the SNS server 100 and the wireless device 200 in the system configured as described above will be described. In this embodiment and other embodiments, the operations of the SNS server 100 and the wireless device 200 are performed in cooperation with the respective CPUs, other hardware, and software executed under the control thereof.

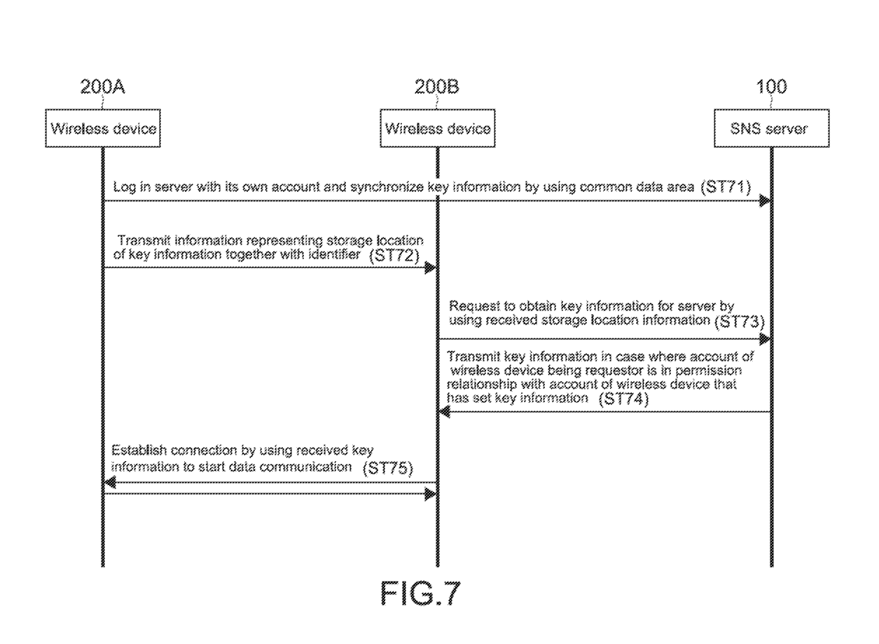

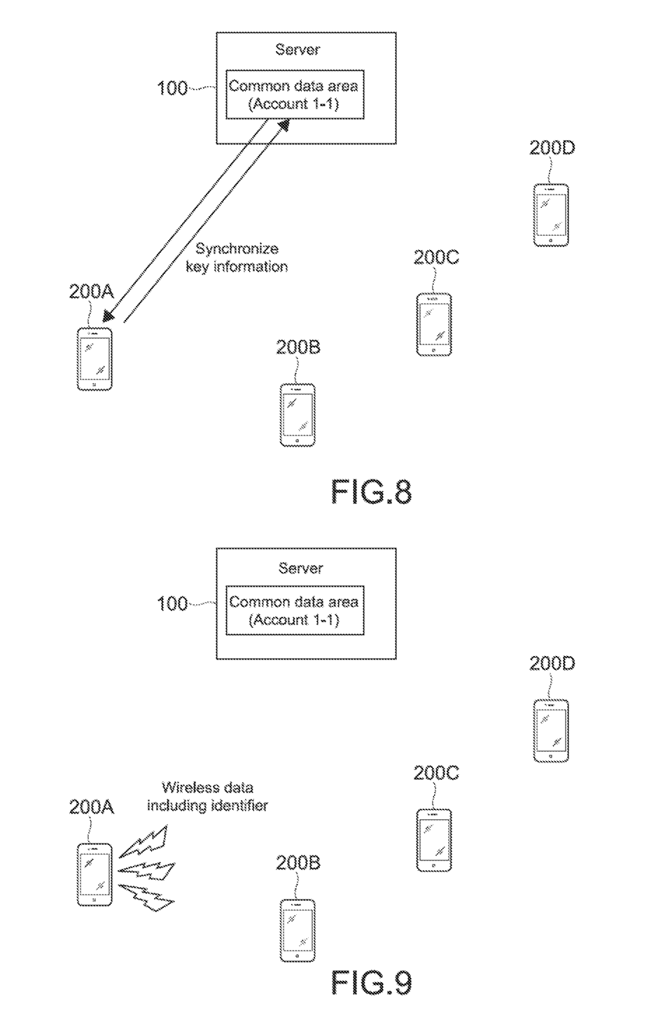

FIG. 7 is a sequence diagram showing flow of an operation of the system according to this embodiment. Moreover, FIGS. 8 to 12 are diagrams schematically showing the flow of the operation step by step.

In FIG. 7, a case where a different wireless device tries to perform a wireless connection with the wireless device 200A will be described as an example. Moreover, FIG. 7 shows data exchange between the wireless device 200A and the wireless device 200B as an example. However, the different wireless devices 200C and 200D also can exchange data similarly.

As shown in FIG. 7, first, the wireless device 200A accesses the SNS server 100 by the communication unit 29, and logs in the SNS server 100 with the account 1-1.

Then, the wireless device 200A uploads key information (e.g., predetermined character, number, sign, and a combination thereof) determined in advance into the common data area in the SNS server 100. Alternatively, the wireless device 200A downloads predetermined data that is already present in the common data area, and sets a part of the downloaded data to the communication unit 29 or the storage unit 28 as the key information.

Hereinafter, any one of the two operations related to the key information is referred to as “synchronization of key information” between the SNS server 100 and the wireless device 200 (Step (ST) 71 in FIG. 7, FIG. 8).

When the wireless device 200A communicates with the SNS server 100, the wireless communication unit or wired communication unit may be used as the communication unit 29.

Next, the wireless device 200A sets the key information synchronized with the SNS server 100 as an encryption key of the wireless device 200A. Then, the wireless device 200A transmits, by the communication unit 29 (wireless communication unit), information (e.g., URL for accessing the common data area in the SNS server 100) representing the storage location of the key information together with its own identifier (Step 72 in FIG. 7, FIG. 9).

Here, the identifier is, for example, an SSID (Service Set Identifier) in Wi-Fi or Wi-Fi Direct network. However, it is not limited thereto. The identifier is transmitted as a beacon at a predetermined interval, and the different wireless device 200 can receive the identifier without performing specific processing such as decryption to recognize the identifier as an SSID.

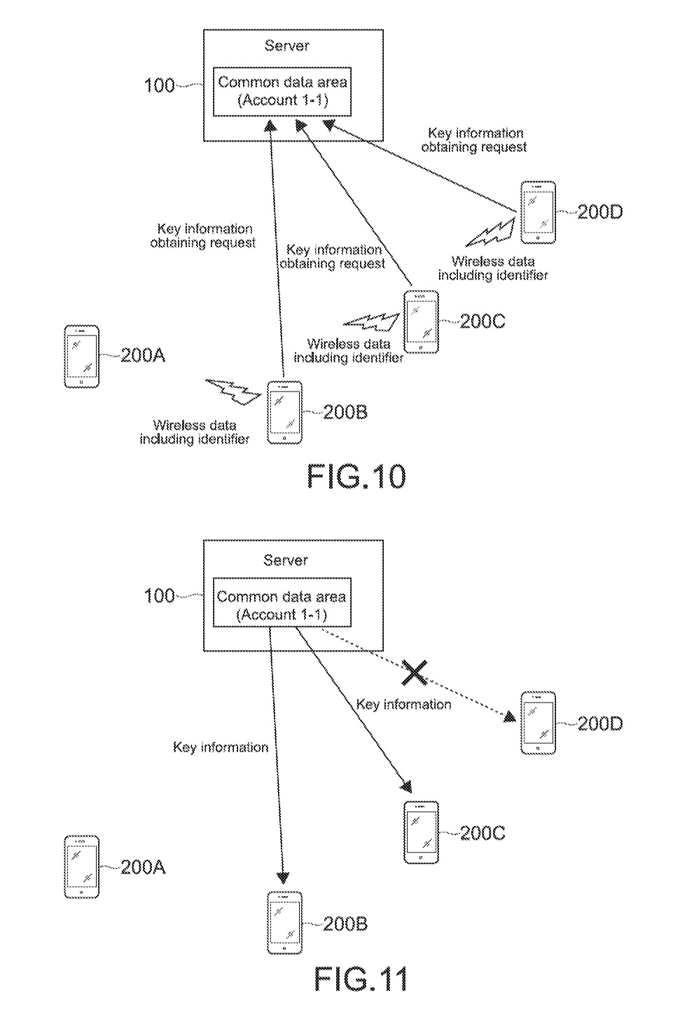

When receiving the transmitted identifier by the communication unit 29 (wireless communication unit), the wireless device 200B extracts the storage location information from the identifier and accesses the SNS server 100 by using the storage location information to log in the SNS server 100 with its own account 1-2. Then, the wireless device 200B accesses the common data area of the account 1-2 and the account 1-1 of the wireless device 200A to request to obtain the key information (Step 73 in FIG. 7, FIG. 10). The different wireless devices 200C and 200D perform the operation similarly.

Communication between the wireless device 200B and the SNS server 100 may also be performed by any one of the wireless communication unit and the wired communication unit.

Here, in the case where a wireless device other than the wireless device 200A transmits the identifier, the wireless device 200B may display a list of a plurality of wireless devices whose identifiers can be recognized, prior to the request processing of the key information for the SNS server 100. Then, the wireless device 200B may use reception of a user's operation of selecting the wireless device 200A from the list as a trigger to perform the key information obtaining request.

The SNS server 100 receives an access request (key information obtaining request) for the common data area by the communication unit 19. Then, the SNS server 100 determines, based on the permission list, whether or not the account 1-2 of the wireless device 200B being a requester is in a permission relationship with the account 1-1 of the wireless device 200A. In the case where the account of the wireless device 200B is determined to be in a permission relationship with the account of the wireless device 200A, the SNS server 100 transmits, to the wireless device 200B, the key information in the common data area by the communication unit 19 (Step 74 in FIG. 7, FIG. 11).

Moreover, in the case where the log-in with the account 1-2 of the wireless device 200B is not permitted, or it is determined that there is no permission relationship based on the permission list even if the log-in is permitted, the SNS server 100 transmits the result to the wireless device 200B.

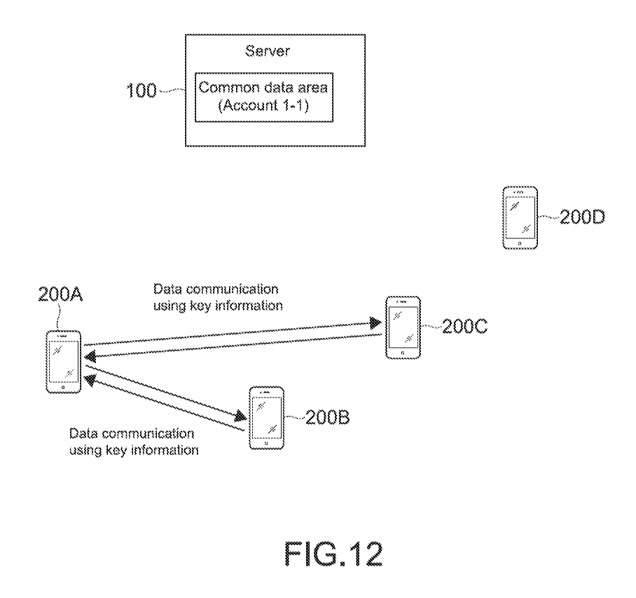

Then, the wireless device 200B requests to establish a connection with the wireless device 200A by using the key information received from the SNS server 100. When receiving the request, the wireless device 200A determines whether or not the received key information is identical to the key information set by the synchronization between the wireless device 200A and the SNS server 100. In the case where the received key information is identical to the key information set by the synchronization between the wireless device 200A and the SNS server 100, the wireless device 200A establishes a wireless connection with the wireless device 200B to start data communication (Step 75 in FIG. 7, FIG. 12).

The wireless device 200C can also obtain the key information from the SNS server 100 and establish a wireless connection with the wireless device 200A in the same procedure (see FIG. 11 and FIG. 12). On the other hand, even if the wireless device 200D accesses the SNS server 100 based on the storage location information, because the account 1-4 of the wireless device 200D is not included in the permission list of the account 1-1 of the wireless device 200A (see FIG. 6), it is difficult for the wireless device 200D to obtain the key information (see FIG. 11).

As described above, according to this embodiment, each of the wireless devices 200 can download the key information from the SNS server 100 by receiving the identifier including the storage location information of the key information from the wireless device 200 being a destination, and can establish a wireless communication with the wireless device 200 being a destination (complete setting up processing) by using the key information. In the setting up processing, because it does not need a button-pressing operation or input operation of PIN by a user as compared to the existing method, the user can reduce the trouble of setting up processing. Moreover, because the key information is stored in the limited access common data area in the SNS server, the security of the key information is ensured. Moreover, because the storage location information of the key information is transmitted as a beacon, and the obtaining processing of the key information is performed between the wireless device 200 and the SNS server 100, a session overlap does not occur and the plurality of wireless devices 200 can concurrently obtain the key information to perform the setting up processing.

### Second Embodiment

Next, a second embodiment of the present disclosure will be described. In this embodiment, components not particularly described have the same configuration as that of the first embodiment. Moreover, devices and blocks having the same configuration and function as those of the first embodiment are denoted by the same reference symbols.

In the first embodiment, only one SNS server 100 is provided on the network 50. However, in the second embodiment, a plurality of (e.g., two) SNS servers 100 are provided. The two SNS servers 100 are referred to as SNS server 100A (or SNS server A) and SNS server 100B (or SNS server B).

### [Account List of Wireless Device]

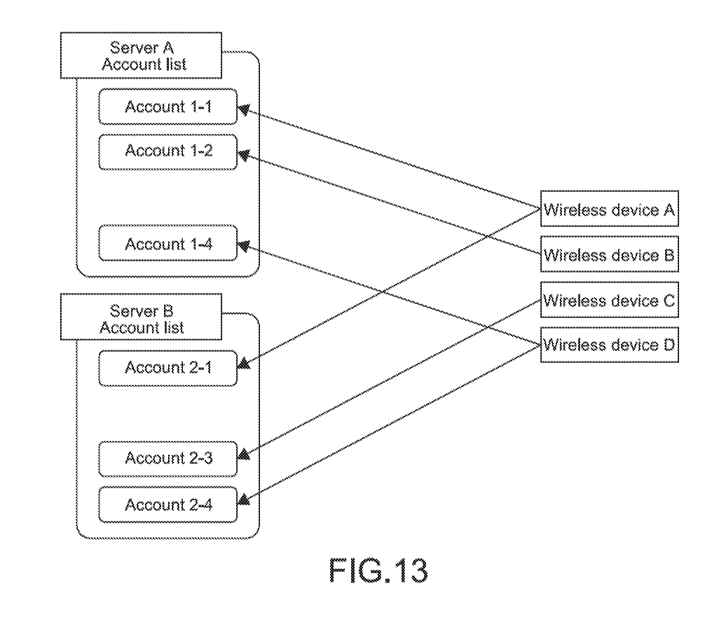

FIG. 13 is a diagram showing a list of the accounts of the users of the wireless devices 200 for the plurality of SNS servers 100A and 100B according to this embodiment.

The SNS servers 100A and 100B provide different SNS, and at least the wireless device 200A of the wireless devices 200 has different accounts of the SNS servers 100A and 100B.

As shown in FIG. 13, the wireless device A has the account 1-1 of the SNS server A and an account 2-1 of the SNS server B. Moreover, the wireless device B has only the account 1-2 of the SNS server A, and the wireless device C has only an account 2-3 of the SNS server B. The wireless device D has, similarly to the wireless device A, the account 1-4 of the SNS server A and an account 2-4 of the SNS server B.

### [Permission Relationship Between Accounts]

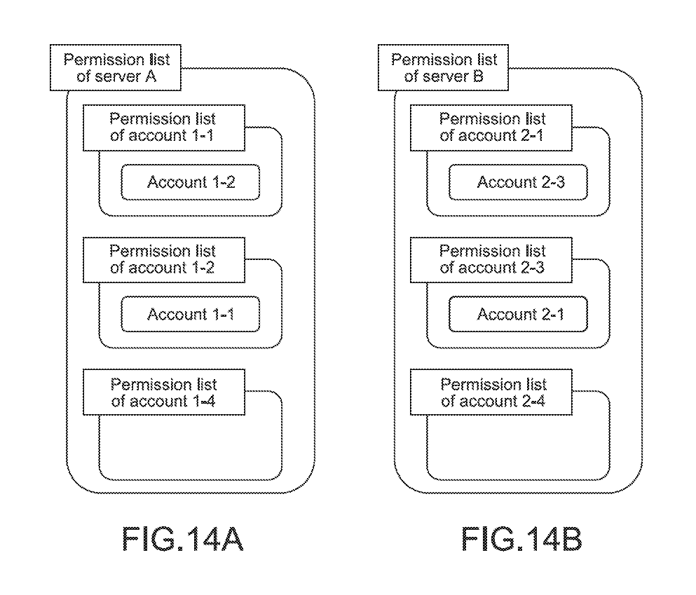

FIGS. 14 are each a diagram showing a permission relationship (permission list) between the accounts of the users of the wireless devices 200 shown in FIG. 13.

As shown in FIG. 14A, in the SNS server 100A, the user having the account 1-1 (wireless device 200A) permits the user having the account 1-2 (wireless device 200B), and the user having the account 1-2 (wireless device 200B) permits the user having the account 1-1. On the other hand, the user having the account 1-4 (wireless device 200D) does not permit any user.

Moreover, as shown in FIG. 14B, in the SNS server 100B, the user having the account 2-1 permits the user having the account 2-3, and the user having the account 2-3 permits the user having the account 2-1. On the other hand, the user having the account 2-4 does not permit any user.

### [Operation of System]

Next, operations of the SNS servers 100A and 100B and wireless devices 200 in the system configured as described above will be described.

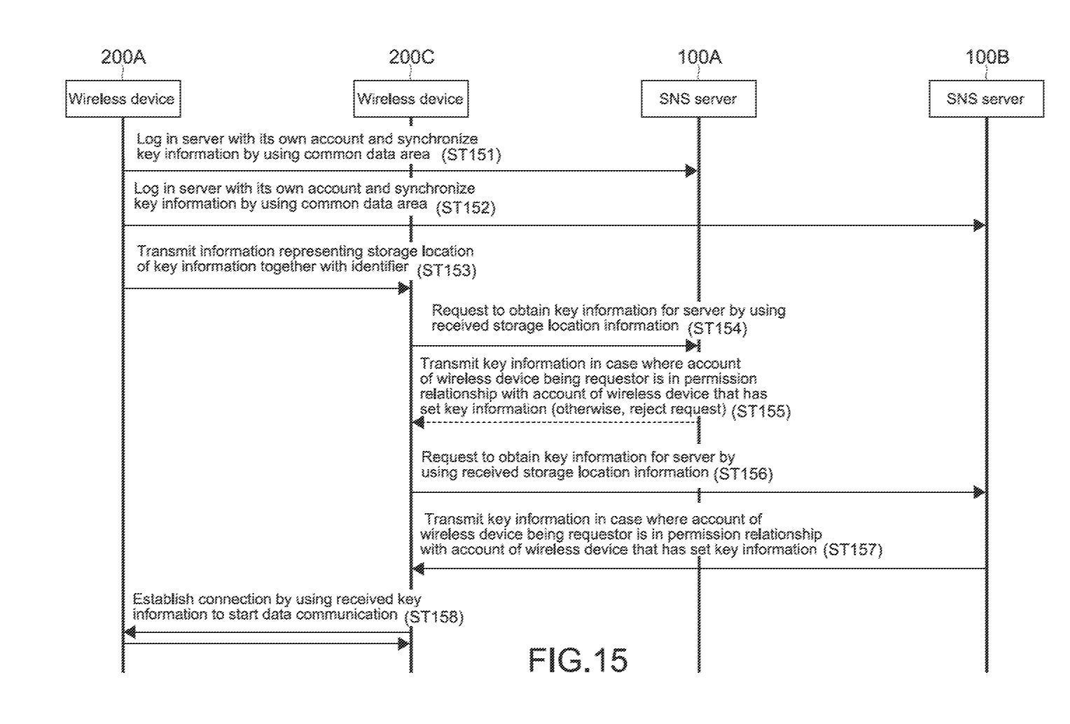

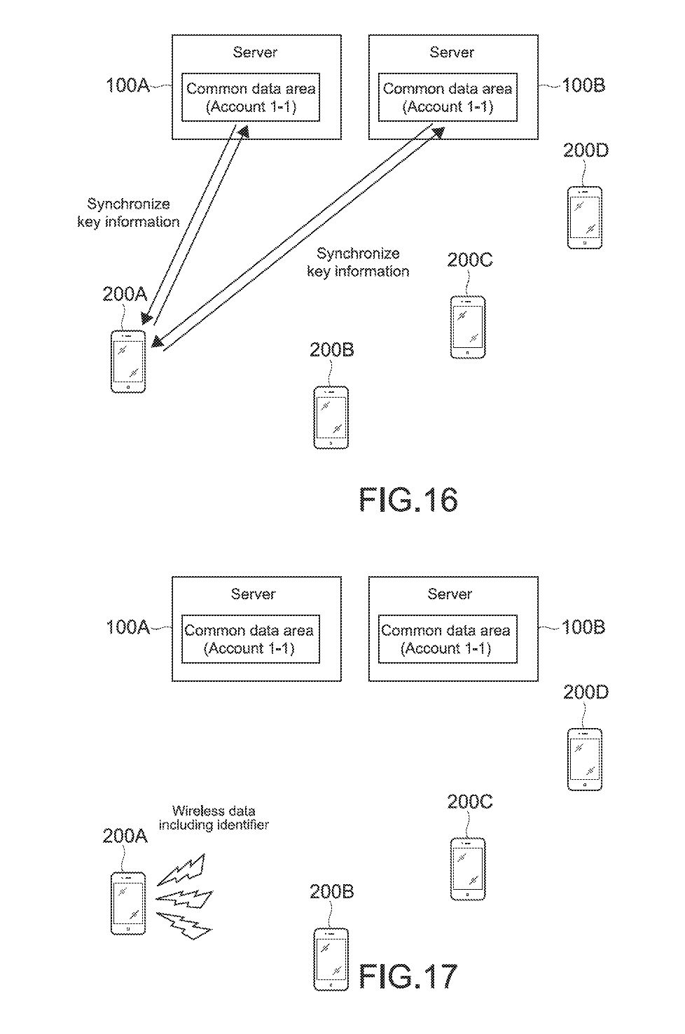

FIG. 15 is a sequence diagram showing flow of an operation of a system according to this embodiment. Moreover, FIGS. 16 to 22 are diagrams schematically showing the flow of the operations step by step.

FIG. 15 describes, as an example, a case where a different wireless device tries to wirelessly connect to the wireless device 200A. Moreover, FIG. 15 shows, as an example, data exchange between the wireless device 200A and the wireless device 200C. However, different wireless devices, i.e., wireless devices 200B and 200D can also exchange data similarly.

As shown in FIG. 15, first, the wireless device 200A accesses, by the communication unit 29, the SNS server 100A to log in the SNS server 100A with the account 1-1, and synchronizes the key information with the SNS server 100A by using information of the common data area corresponding to the account 1-1 (Step 151 in FIG. 15, FIG. 16).

Moreover, the wireless device 200A accesses, by the communication unit 29, the SNS server 100B to log in the SNS server 100B with the account 2-1, and synchronizes the key information with the SNS server 100B by using information of the common data area corresponding to the account 2-1 (Step 152 in FIG. 15, FIG. 16).

Here, the key information synchronized with the SNS server 100A by the wireless device 200A may be identical to or different from the key information synchronized with the SNS server 100B by the wireless device 200A.

Next, the wireless device 200A sets the key information synchronized with the SNS server 100A or 100B as an encryption key of the wireless device 200A. Then, the wireless device 200A transmits, by the communication unit 29 (wireless communication unit), information (e.g., URL) representing the storage location of the key information together with its own identifier (Step 153 in FIG. 15, FIG. 17).

Here, as a method for the wireless device 200A to transmit the identifier, the following two methods are considered.

One method is to combine the storage location information in the SNS server 100A and the storage location information in the SNS server 100B, and to transmit the combined information together with the identifier.

The other method is to separately create a wireless communication interface for the SNS server 100A and the SNS server 100B, and to transmit, as separate data, the identifier including the storage location information in one of the SNS servers 100 by the respective interfaces.

Next, when receiving, by the communication unit 29 (wireless communication unit), the transmitted identifier, the wireless device 200C extracts, from the identifier, each storage location information in the SNS servers 100A and 100B.

Then, the wireless device 200C sequentially tries to access the respective SNS servers 100 to obtain the key information.

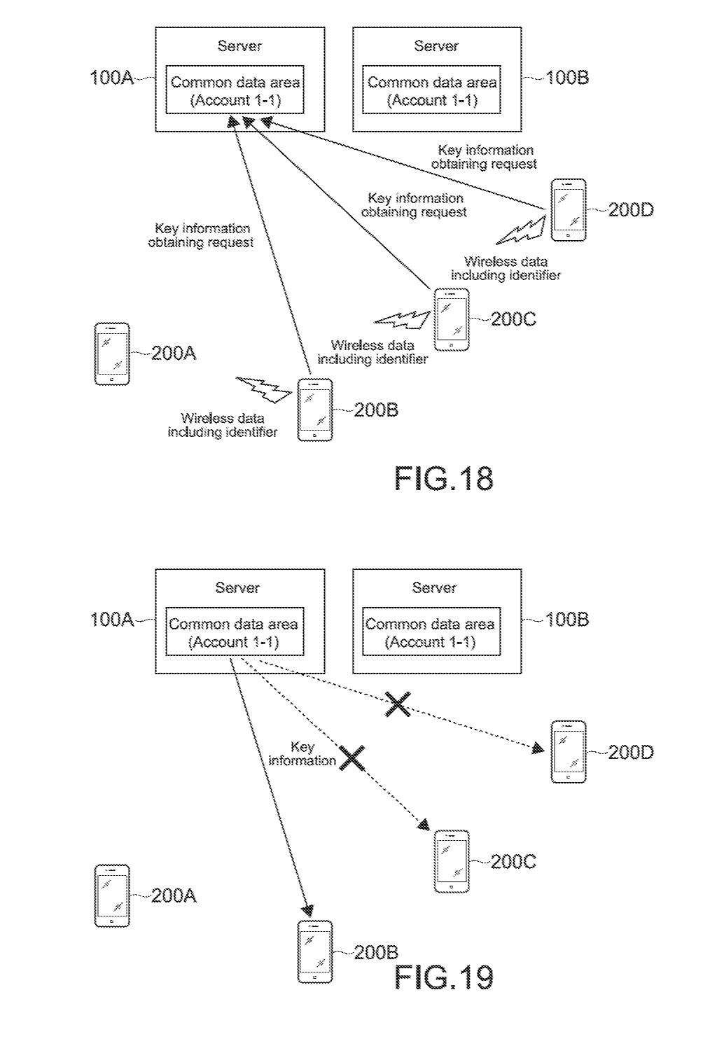

For example, the wireless device 200C first accesses the SNS server 100A by using the storage location information in the SNS server 100A, and requests to obtain the key information (Step 154 in FIG. 15, FIG. 18). The different wireless devices 200B and 200D perform the operation similarly. Needless to say, the wireless devices 200 may try to obtain the key information from the SNS server 100B first.

The SNS server 100A receives, by the communication unit 19, an access request (key information obtaining request) for the common data area. However, because the wireless device 200C does not have an account of the SNS server 100A (see FIG. 13), the SNS server 100A rejects the key information obtaining request (Step 155 in FIG. 15, FIG. 19)

On the other hand, for example, because the wireless device 200B has the account 1-2 of the SNS server 100A and the account 1-2 is in a permission relation with the account 1-1 of the wireless device 200A, the wireless device 200B can obtain the key information from the SNS server 100A (see FIG. 19). Moreover, the wireless device 200D has an account of the SNS server 100A, but the account is not in a permission relationship with the account 1-1 of the wireless device 200A. Therefore, it is difficult for the wireless device 200D to obtain the key information from the SNS server 100A (see FIG. 19).

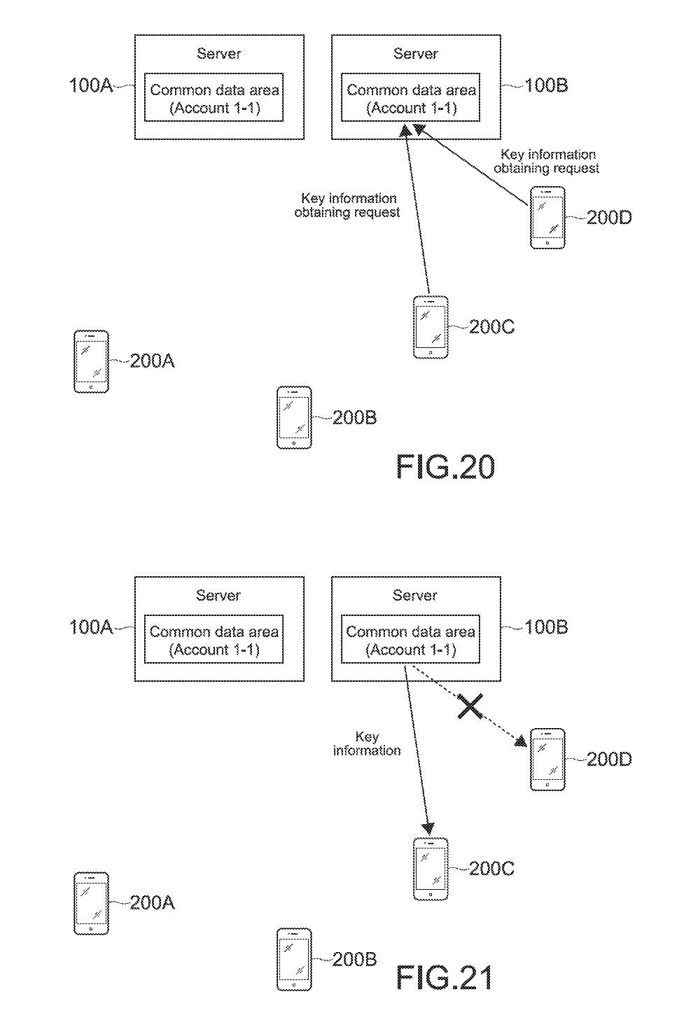

Next, the wireless device 200C whose key information obtaining request is rejected by the SNS server 100A access the SNS server 100B by using the storage location information in the SNS server 100B to log in the SNS server 100B with its own account 2-3. Then, the wireless device 200C accesses the common data area of the account 2-3 and the account 2-1 of the wireless device 200A to request to obtain the key information (Step 156 in FIG. 15, FIG. 20).

Then, the SNS server 100B determines, based on the permission list, whether or not the account 2-3 of the wireless device 200C being a requestor is in a permission relationship with the account 2-1 of the wireless device 200A. In the case where the account of the wireless device 200C is determined to be in a permission relationship with the account of the wireless device 200A, the SNS server 100B transmits, by the communication unit 19, the key information in the common data area to the wireless device 200C (Step 157 in FIG. 15, FIG. 21).

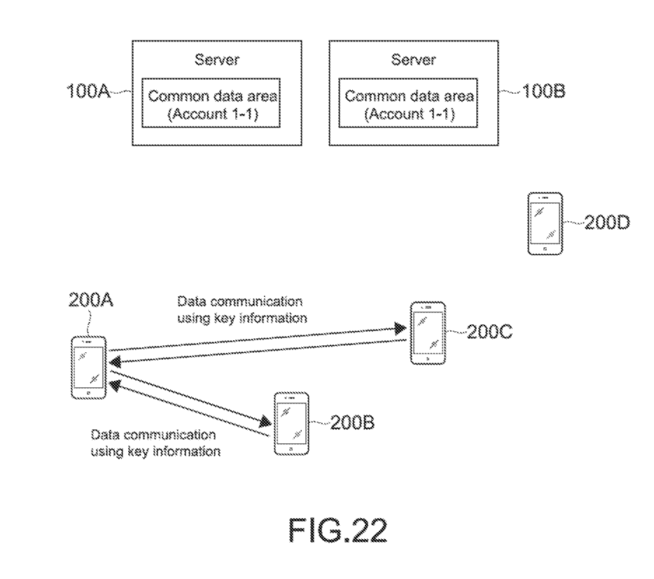

Then, the wireless device 200C requests to establish a connection with the wireless device 200A by using the key information received from the SNS server 100B. When receiving the request, the wireless device 200A determines whether or not the received key information is identical to the key information set by the synchronization with the SNS servers 100A or 100B (key information in one of the servers in the case where key information is set for each server). In the case where the received key information is identical to the key information set by the synchronization with the SNS servers 100A or 100B, the wireless device 200A establishes a wireless communication with the wireless device 200C and starts data communication (Step 158 in FIG. 15, FIG. 22).

The wireless device 200B can establish a communication with the wireless device 200A and perform data communication by using the key information received from the SNS server 100A, similarly (see FIG. 22).

On the other hand, next, also the wireless device 200D whose key information obtaining request is rejected by the SNS server 100A transmits a key information obtaining request to the SNS server 100B, similarly to the wireless device 200C. However, although the wireless device 200D has an account of the SNS server 100B, the account is not in a permission relationship with the account 2-1 of the wireless device 200A. Therefore, it is difficult for the wireless device 200D to obtain the key information from the SNS server 100B (see FIG. 21).

### [Effect]

As described above, according to this embodiment, the wireless device 200A has accounts of a plurality of SNS servers 100, and stores key information in a common data area of each server. Therefore, even in the case where the wireless devices 200 have accounts of different SNS servers 100 or permitted friends are different for each server 100, the users of the wireless devices 200 can obtain the key information from any one of the SNS servers 100 without considering the difference.

### Modified Example

The present disclosure is not limited to the above-mentioned embodiments, and various modifications can be made without departing from the gist of the present disclosure.

### Modified Example 1

In the above-mentioned embodiments, a case where the key-information is set by the wireless device 200A in advance to be uploaded into the SNS server 100 has been described. However, as the key information, for example, a part of data that is already present on a network may be used.

For example, the key information may be one of a character and a sign, which are described at a predetermined location on a predetermined web page. In order to access the web page, it may be unnecessary to log in. More specifically, the key information may be, for example, a character string (e.g., first to fifth characters) included in top news headlines at a predetermined location (in a predetermined range) on a predetermined web portal.

In this case, the wireless device 200 that synchronizes the key information designates the URL of the web page as a URL included in the identifier, and thereafter adds information representing the location of the characters (e.g., 1-5, if the key information is first to fifth characters) as the storage location information to transmit the identifier.

Moreover, the wireless device 200 being a connection requester that receives such an identifier accesses the web page by using the storage location information, and extracts and receives, as the key information, the character string or the like based on the information representing the location of the characters.

Accordingly, the wireless device 200 that synchronizes the key information allows the different wireless device 200 to obtain the key information without uploading the key information to any location such as a server.

In this case, the key information may be a temporary key that is valid only when establishing a connection between the wireless devices 200. For example, the top news on the web portal described in the above-mentioned example is updated at each predetermined time period. Therefore, if the characters included in the news are used as the key information, a certain level of security is ensured even if access restrictions are not applied.

### Modified Example 2

In the above-mentioned embodiments, the key information is stored in the common data area in the SNS server 100. However the storage location of the key information is not limited thereto. For example, the key information may be stored in a server that provides service other than SNS, in storage (HDD apparatus or the like) on a network, which provides no service, or in a local storage location.

For example, the key information may be stored in the wireless device 200 itself, which sets the key information. In this case, also the account list or permission list (friend list) described above may be downloaded from the SNS server 100 into the wireless device in advance. Accordingly, the wireless device 200 can determine whether or not there is an account of the wireless device 200 being a connection source and whether or not there is a permission relationship, instead of the SNS server 100 in the above-mentioned embodiments.

### Modified Example 3

In the second embodiment, the obtaining processing of key information on the plurality of SNS servers 100 is sequentially tried to be performed. However, in the obtaining processing of key information, the SNS server 100 of which the user of the wireless device 200 has the account may be preferentially accessed, and the SNS server 100 of which the user has no account does not need to be accessed. In this case, each of the wireless devices 200 has a mechanism (program) for determining whether or not the wireless device 200 has an account of a predetermined SNS server 100.

### Modified Example 4

In the above-mentioned embodiments, the operations of the wireless devices 200 have been described such that the operations are performed in cooperation with a CPU, which integrally controls other various types of hardware such as a communication unit, and software executed by the CPU. However, the present disclosure is not limited to a case where it is realized by the CPU, which integrally controls other hardware. The present disclosure may be realized by a dedicated IC (Integrated Circuit) for performing the operations in combination, and may be realized by cooperative processing of such an IC and software. As the IC, at least one of an MPU (Micro Processing Unit), a DSP (Digital Signal Processor), an FPGA (Field Programmable Gate Array), an ASIC (Application Specific Integrated Circuit), and the like may be used.

### [Others]

The present disclosure may also take the following configurations.

(1) An information processing apparatus, including:

a communication unit; and

a control unit configured to be capable of controlling the communication unit
to receive, from a different information processing apparatus, storage location information representing a storage location of key information necessary for encrypted wireless communication with the different information processing apparatus,
to access the storage location represented by the storage location information to receive the key information, and
to establish a connection with the different information processing apparatus by using the received key information.

(2) The information processing apparatus according to (1), in which
the control unit is configured to control the communication unit to access the storage location by using permission information representing that access to the storage location is permitted by a user of the different information processing apparatus.

(3) The information processing apparatus according to (2), in which

the storage location is a first data area on a first SNS server, the first data area corresponding to a first account for logging in the first SNS server, the user of the different information processing apparatus having the first account, and

the control unit is configured to use, as the permission information, an account of a user of the information processing apparatus, which is included in a first friend list corresponding to the first account of the user of the different information processing apparatus.

(4) The information processing apparatus according to (3), in which

the storage location includes the first data area on the first SNS server and a second data area on a second SNS server, the second data area corresponding to a second account for logging in the second SNS server, the user of the different information processing apparatus having the second account, the second SNS server being different from the first SNS server, and

the control unit is configured to control the communication unit to use, as the permission information, an account of the user of the information processing apparatus, which is included in at least one of the first friend list and a second friend list, to receive the key information from at least one of the first data area and the second data area, the second friend list corresponding to the second account for logging in the second SNS server, the user of the different information processing apparatus having the second account.

(5) The information processing apparatus according to any one of (1) to (4), in which

the storage location information is transmitted, as a beacon, from the different information processing apparatus together with an identifier at a predetermined interval, the identifier identifying the different information processing apparatus.

(6) The information processing apparatus according to (1) or (5), in which

the key information is one of a character and a sign, which are described at a predetermined location on a predetermined web page, and

the control unit is configured to control the communication unit
to receive, as the storage location information, information representing a URL of the web page and the predetermined location, and
to extract and receive, as the key information, one of the character and the sign from the predetermined position on the web page.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a communication unit; and
a control unit configured to be capable of controlling the communication unit
to receive, from a different information processing apparatus, storage location information representing a storage location of key information necessary for encrypted wireless communication with the different information processing apparatus,
to access the storage location represented by the storage location information to receive the key information, and
to establish a connection with the different information processing apparatus by using the received key information.

2. The information processing apparatus according to claim 1, wherein
the control unit is configured to control the communication unit to access the storage location by using permission information representing that access to the storage location is permitted by a user of the different information processing apparatus.

3. The information processing apparatus according to claim 2, wherein
the storage location is a first data area on a first social networking service server, the first data area corresponding to a first account for logging in the first social networking service server, the user of the different information processing apparatus having the first account, and
the control unit is configured to use, as the permission information, an account of a user of the information processing apparatus, which is included in a first friend list corresponding to the first account of the user of the different information processing apparatus.

4. The information processing apparatus according to claim 3, wherein
the storage location includes the first data area on the first social networking service server and a second data area on a second social networking service server, the second data area corresponding to a second account for logging in the second social networking service server, the user of the different information processing apparatus having the second account, the second social networking service server being different from the first social networking service server, and
the control unit is configured to control the communication unit to use, as the permission information, an account of the user of the information processing apparatus, which is included in at least one of the first friend list and a second friend list, to receive the key information from at least one of the first data area and the second data area, the second friend list corresponding to the second account for logging in the second social networking service server, the user of the different information processing apparatus having the second account.

5. The information processing apparatus according to claim 1, wherein
the storage location information is transmitted, as a beacon, from the different information processing apparatus together with an identifier at a predetermined interval, the identifier identifying the different information processing apparatus.

6. The information processing apparatus according to claim 1, wherein
the key information is one of a character and a sign, which are described at a predetermined location on a predetermined web page, and
the control unit is configured to control the communication unit
to receive, as the storage location information, information representing a URL of the web page and the predetermined location, and
to extract and receive, as the key information, one of the character and the sign from the predetermined position on the web page.

7. An information processing system, comprising:
an information processing apparatus, including
a first communication unit; and
a first control unit configured to be capable of controlling the first communication unit
to receive, from a different information processing apparatus, storage location information representing a storage location of key information necessary for encrypted wireless communication with the different information processing apparatus,
to access the storage location represented by the storage location information to receive the key information, and
to establish a connection with the different information processing apparatus by using the received key information, and
a server, including
a storage unit including the storage location,
a second communication unit, and
a second control unit configured to be capable of controlling the second communication unit
to authenticate access authority from the information processing apparatus, and
to transmit the key information stored at the storage location to the information processing apparatus in a case where the access authority is permitted.

8. An information processing method, comprising
receiving, from a different information processing apparatus, storage location information representing a storage location of key information necessary for encrypted wireless communication with the different information processing apparatus,
accessing the storage location represented by the storage location information to receive the key information, and
establishing a connection with the different information processing apparatus by using the received key information.

9. A program that causes an information processing apparatus to execute the steps of:
receiving, from a different information processing apparatus, storage location information representing a storage location of key information necessary for encrypted wireless communication with the different information processing apparatus,
accessing the storage location represented by the storage location information to receive the key information, and
establishing a connection with the different information processing apparatus by using the received key information.
